(19) United States
(12) Patent Application Publication
(10) Pub. No.: US 2018/0220081 A1
(43) Pub. Date: Aug. 2, 2018

(54) METHOD AND APPARATUS FOR AUGMENTING REARVIEW DISPLAY

(71) Applicant: GM GLOBAL TECHNOLOGY OPERATIONS LLC, Detroit, MI (US)

(72) Inventors: Allan Lewis, Windsor (CA); Mohammad Naserian, Windsor (CA); Michael Chaney, JR., Royal Oak, MI (US)

(21) Appl. No.: 15/419,235

(22) Filed: Jan. 30, 2017

(51) Int. Cl. H04N 5/272; H04N 7/18; H04N 5/232; G06T 7/13; B60R 1/00; B60R 1/12; B60R 11/04

(52) U.S. Cl. CPC H04N 5/272; H04N 7/181; H04N 5/23293; G06T 7/13; G06F 3/04842; B60R 1/12; B60R 11/04; G06T 2200/24; B60R 1/00

(57) ABSTRACT

A method and apparatus for augmenting a rear view display are provided. The method includes: detecting a condition for augmenting a rear view display; and in response to detecting the condition for augmenting the rear view display, receiving a first image from a first camera facing an first area behind a vehicle and displaying the received first image on the rear view display. The method may be used to augment rear view displays to provide an unobstructed view when a view displayed on the rear view display is obstructed.

### INTRODUCTION

Apparatuses and methods consistent with exemplary embodiments relate to rear view displays. More particularly, apparatuses and methods consistent with exemplary embodiments relate to augmenting rearview displays.

### SUMMARY

One or more exemplary embodiments provide a method and an apparatus that augment rear view displays with images from rear facing cameras. More particularly, one or more exemplary embodiments provide a method and an apparatus that augments a rear view display providing an obstructed view from a first camera with an unobstructed view from a second camera.

According to an aspect of an exemplary embodiment, a method for augmenting a rear view display. The method includes: detecting a condition for augmenting a rear view display; and in response to detecting the condition for augmenting the rear view display, receiving a first image from a first camera facing an first area behind a vehicle and displaying the received first image on the rear view display.

The detecting a condition for augmenting a rear view display may include: detecting that a tailgate of the vehicle is closed, and in response to detecting that the tailgate of the vehicle is closed, detecting a user selection of an option to augment the rear view display.

The detecting a condition for augmenting a rear view display may include: detecting that a tailgate of the vehicle is closed, and in response to detecting that the tailgate of the vehicle is closed: performing an edge detection algorithm to detect edges of a tailgate and bed in a second image received from a second camera facing a second area behind a vehicle; and determining that a portion of the edges of the tailgate and bed that is obscured is greater than a predetermined calibration value based on the edge detection algorithm.

The displaying the received first image on the rear view display may include: determining whether the portion that is obscured is required to be displayed; determining a location of the portion that is obscured and that is required to be displayed; determining a dimension of the portion that is obscured and that is required to be displayed; determining a portion of the first image that corresponds to the portion that is obscured in the second image; and cropping and superimposing the portion of the first image that corresponds to the portion that is obscured in the second image onto the portion that is obscured in the second image.

The displaying the received first image on the rear view display may include cropping and superimposing the received first image on the rear view display.

The rear view display may be a rear view mirror, and the displaying the received first image on the rear view display may include cropping and superimposing the received first image on at least a portion of the rear view mirror.

The rear view display may be a center stack display, and the displaying the received first image on the rear view display may include cropping and superimposing the received first image on at least a portion of the center stack display.

The first camera may include a rear vision back up camera located on a tailgate or a trunk of vehicle.

The rear view display may be displaying an image taken by a center high-mounted stop light camera, and the displaying the received first image on the rear view display comprises cropping and superimposing the received first image on at least a portion of the image taken by the center high-mounted stop light camera.

According to an aspect of another exemplary embodiment, an apparatus for augmenting a rear view display is provided. The apparatus includes: at least one memory comprising computer executable instructions; and at least one processor configured to read and execute the computer executable instructions. The computer executable instructions cause the at least one processor to: detect a condition for augmenting a rear view display; and in response to detecting the condition for augmenting the rear view display, receive a first image from a first camera facing an first area behind a vehicle and control to display the received first image on the rear view display.

The computer executable instructions may further cause the at least one processor to detect a condition for augmenting a rear view display by: detecting that a tailgate of the vehicle is closed; and in response to detecting that the tailgate of the vehicle is closed, detecting a user selection of an option to augment the rear view display.

The computer executable instructions may cause the at least one processor to detect a condition for augmenting a rear view display by: detecting that a tailgate of the vehicle is closed, and in response to detecting that the tailgate of the vehicle is closed: performing an edge detection algorithm to detect edges of a tailgate and bed in a second image received from a second camera facing a second area behind a vehicle; and determining that a portion of the edges of the tailgate and the bed that is obscured is greater than a predetermined calibration value based on the edge detection algorithm.

The computer executable instructions may cause the at least one processor to control to display the received first image on the rear view display by: determining whether the portion that is obscured is required to be displayed; determining a location of the portion that is obscured and that is required to be displayed; determining a dimension of the portion that is obscured and that is required to be displayed; determining a portion of the received first image that corresponds to the portion that is obscured in the second image; and cropping and superimposing the portion of the first image that corresponds to the portion that is obscured in the second image onto the portion that is obscured in the second image.

The apparatus may further include a rear view display including at least one from among a rear view mirror, a center stack display, an instrument panel display, and a heads up display.

The computer executable instructions may cause the at least one processor to control to display the received first image on the rear view display by cropping and superimposing the received first image on the rear view display.

The apparatus may further the first camera located on the rear portion of the vehicle, and the first camera may be a rear vision back up camera located on a tailgate or a trunk of vehicle.

The apparatus may further include a center high-mounted stop light camera, and the computer executable instructions cause the at least one processor to control the rear view display to display an image taken by the center high-mounted stop light camera.

The computer executable instructions cause the at least one processor to control to display the received first image on the rear view display by cropping and superimposing the received image on at least a portion of the image taken by the center high-mounted stop light camera.

According to an aspect of another exemplary embodiment, a non-transitory computer readable medium comprising computer executable instructions executable by a processor to perform a method for augmenting a rear view display of a vehicle is provided. The method includes: detecting an obstruction in a first image taken by a center high-mounted stop light camera; in response to detecting the obstruction, receiving a second image from a second camera located on a rear portion of a vehicle; and displaying at least a part of second image in place of a part of the first image on the rear view display.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that augments a rear view display according to an exemplary embodiment;

FIG. 2 shows a flowchart for a method of augmenting a rear view display according to an exemplary embodiment;

FIG. 3 shows a flowchart for a method of augmenting a rear view display according to another exemplary embodiment;

FIG. 4 shows illustrations of rear facing cameras and their fields of view according to an aspect of an exemplary embodiment; and

FIG. 5 shows illustrations of various views from rear facing cameras according to an aspect of an exemplary embodiment.

### DETAILED DESCRIPTION OF EXEMPLARY EMBODIMENTS

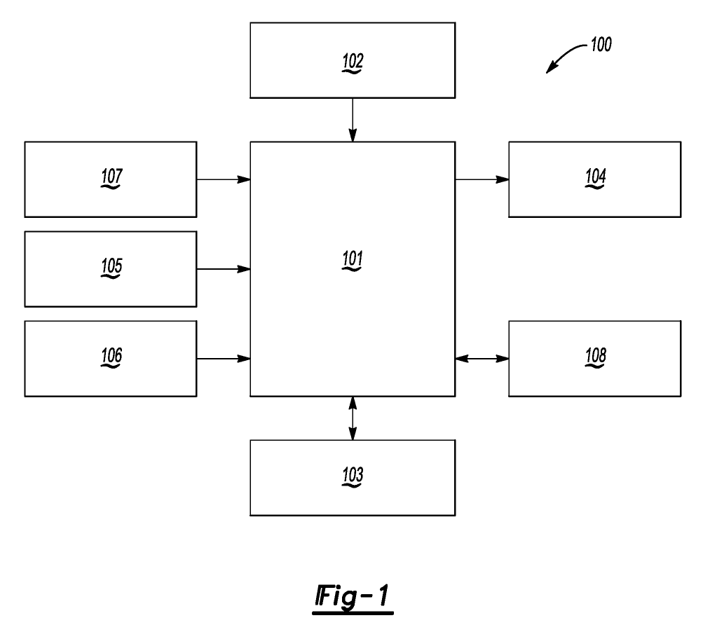

An apparatus and method that augment rear view displays will now be described in detail with reference to FIGS. 1-5 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Vehicles such as trucks may include rear view mirrors and rear view cameras to provide an operator with a view of an area behind vehicle. In addition, a vehicle may include a display that outputs an image provide by a camera facing the area behind the vehicle. Examples of displays may include a center stack display, a side mirror display or a rear view mirror display that output the image provide by a camera facing the area behind the view or an area in the rear of a vehicle such as a vehicle bed.

One example of a rear view camera may be a rear vision back up camera located on a tailgate, a trunk, or bumper of a vehicle. Another example of a rear view camera is a center high-mounted stop light camera (CHMSL) that is mounted near the top of a cab of a pickup truck. A CHMSL provides an operator with a view of truck bed in addition to a view of the area behind the vehicle. However, one issue that may arise with a CHMSL is that its field of view may be obstructed or obscured by a tailgate or by cargo in the bed of the pickup truck.

To address the above issue of obstruction, additional cameras may be mounted on the rear of a vehicle to provide additional views to an operator. However, cycling through views from different cameras may be inconvenient to an operator of vehicle, especially if the vehicle is moving in reverse. Thus, augmenting the display of the obstructed view with an unobstructed view from an additional camera may provide an operator with a convenient solution to the issue of an obstructed view without requiring additional input or work by the operator of the vehicle.

FIG. 1 shows a block diagram of an apparatus that augments a rear view display 100 according to an exemplary embodiment. As shown in FIG. 1, the apparatus that augments a rear view display 100, according to an exemplary embodiment, includes a controller 101, a power supply 102, a storage 103, an output 104, a first rear view camera 105, a user input 106, a second rear view camera 107, and a communication device 108. However, the apparatus that augments a rear view display 100 is not limited to the aforementioned configuration and may be configured to include additional elements and/or omit one or more of the aforementioned elements. The apparatus that augments a rear view display 100 may be implemented as part of a vehicle, as a standalone component, as a hybrid between an on vehicle and off vehicle device, or in another computing device.

The controller 101 controls the overall operation and function of the apparatus that augments a rear view display 100. The controller 101 may control one or more of a storage 103, an output 104, a first rear view camera 105, a user input 106, a second rear view camera 107, and a communication device 108 of the apparatus that augments a rear view display 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 may be configured to send and/or receive information from one or more of the storage 103, the output 104, the first rear view camera 105, the user input 106, the second rear view camera 107, and the communication device 108 of the apparatus that augments a rear view display 100. The information may be sent and received via a bus or network, or may be directly read or written to/from one or more of the storage 103, the output 104, the user input 106, the second rear view camera 107, and the communication device 108 of the apparatus that augments a rear view display 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the controller 101, the storage 103, the output 104, the first rear view camera 105, the user input 106, the second rear view camera 107, and the communication device 108, of the apparatus that augments a rear view display 100. The power supply 102 may include one or more from among a battery, an outlet, a capacitor, a solar energy cell, a generator, a wind energy device, an alternator, etc.

The storage 103 is configured for storing information and retrieving information used by the apparatus that augments a rear view display 100. The storage 103 may be controlled by the controller 101 to store information received from the second rear view camera 107 or the first rear view camera 105 and to retrieve the stored information. The information may include information on one or more images taken by the second rear view camera 107 and/or information on one or more images taken by the first rear view camera 105. In addition, the storage 103 may also include the computer instructions configured to be executed by a processor to perform the functions of the apparatus that augments a rear view display 100.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the apparatus that augments a rear view display 100. The output 104 may include one or more from among a speaker, audio, a display, a centrally-located display, a head up display, a windshield display, a haptic feedback device, a vibration device, a tactile feedback device, a tap-feedback device, a holographic display, an instrument light, an instrument panel display, a center stack display, a rear view mirror display, a side view mirror display, an indicator light, etc.

According to one example, the output 104 may be one or more from among a center stack display, a side mirror display, or a rear view mirror display. The output 104 may be configured to output an image from the first rear view camera 105, an image from the second rear view camera 107, or an augmented image generated by combining images from the first rear view camera 105 and the second rear view camera 107. In addition, the output 104 may output notification including one or more from among an audible notification, a light notification, and a display notification. The notification may include information of an obstruction of the view of the first rear view camera 105 or the second rear view camera.

The user input 106 is configured to provide information and commands to the apparatus that augments a rear view display 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to acknowledge or dismiss the notification output by the output 104. The user input 106 may also be configured to receive a user input to cycle between display modes of the output 104. For example, the user input 106 may be configured to select an image from the first rear view camera 105, an image from the second rear view camera 107, or an augmented image generated by combining images from the first rear view camera 105 and the second rear view camera 107 to be output on the output 104, e.g., a rear view display.

The first rear view camera 105 and the second rear view camera 107 may be one or more from a rear facing camera, a camera, an infrared camera, or a night vision camera. According to an example, the first rear view camera 105 may be a rear view camera mounted on a tailgate, a truck or a bumper of the vehicle and the second rear view camera 107 may be a CHMSL mounted on the cab of a truck, or vice versa. The images from the second rear view camera 107 or the first rear view camera 105 may be analyzed to determine whether they are obstructed. According to an example, the image from the first rear view camera may be cropped and superimposed on at least a portion of the image taken by a center high-mounted stop light camera.

The communication device 108 may be used by apparatus that augments a rear view display 100 to communicate with various types of external apparatuses according to various communication methods. The communication device 108 may be used to send/receive image information from the first rear view camera 105 and the second rear view camera 107. In addition, the communication device 108 may be send image information to the output 104 to be output on a display of the apparatus that augments a rear view display 100.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

According to an example, the controller 101 of the apparatus that augments a rear view display 100 may be configured to detect a condition for augmenting a rear view display; and in response to detecting the condition for augmenting the rear view display, receive a first image from a first camera facing an first area behind a vehicle and control to display the received first image on the rear view display.

According to an example, the controller 101 of the apparatus that augments a rear view display 100 may be configured to detect a condition for augmenting a rear view display by detecting that a tailgate of the vehicle is closed, and in response to detecting that the tailgate of the vehicle is closed, detecting a user selection of an option to augment the rear view display.

According to another example, in response to detecting that the tailgate of the vehicle is closed, the controller 101 of the apparatus that augments a rear view display 100 may be configured to perform an edge detection algorithm to detect edges of a tailgate and bed in a second image received from a second camera facing a second area behind a vehicle; and determine that a portion of the edges of the tailgate and the bed that is obscured is greater than a predetermined calibration value based on the edge detection algorithm.

The controller 101 of the apparatus that augments a rear view display 100 may be configured to control to display the received first image on the rear view display by determining whether the portion that is obscured is required to be displayed, determining a location of the portion that is obscured and that is required to be displayed, determining a dimension of the portion that is obscured and that is required to be displayed, determining a portion of the received first image that corresponds to the portion that is obscured in the second image; and cropping and superimposing the portion of the first image that corresponds to the portion that is obscured in the second image onto the portion that is obscured in the second image.

The controller 101 of the apparatus that augments a rear view display 100 may be configured to determine whether the gate of the vehicle bed is in the closed position by performing an image analysis on an image received from a rear view camera. The rear view camera may capture the image including a horizontal field of view of the vehicle bed and the hitch in the vehicle bed.

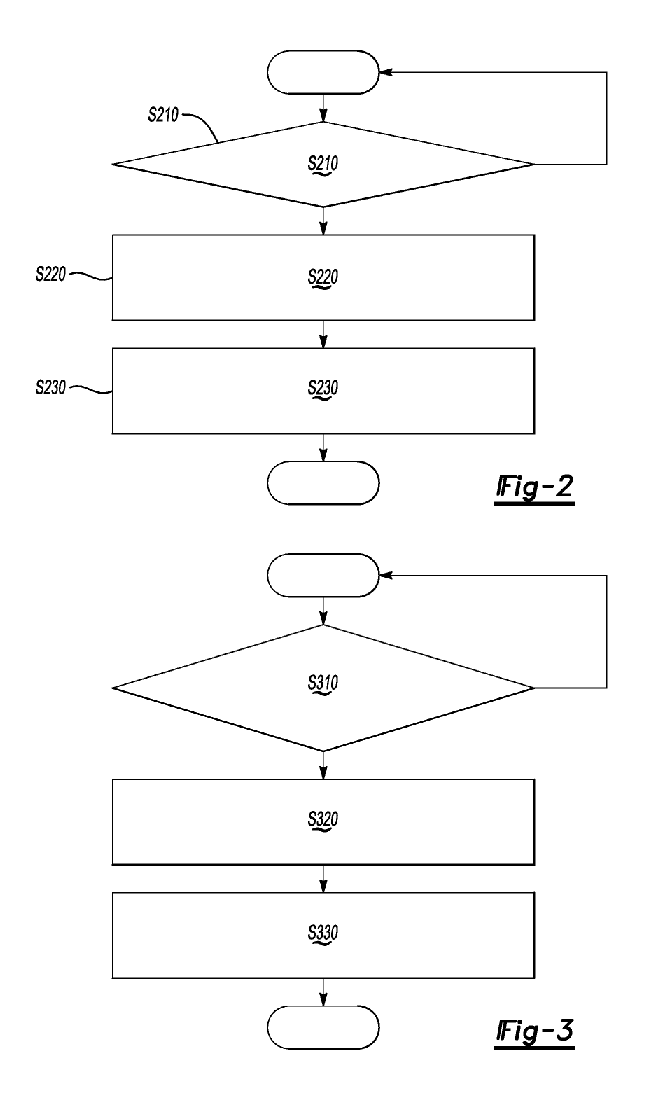

FIG. 2 shows a flowchart for a method for augmenting a rear view display according to an exemplary embodiment. The method of FIG. 2 may be performed by the apparatus that augments a rear view display 100 or may be encoded into a computer readable medium as instructions that are executable by a computer to perform the method.

Referring to FIG. 2, a condition for augmenting a rear view display is continuously checked for in operation 210 and operation S210—No. For example, the condition may be that one of the rear view cameras is active, the image provided by the camera is obstructed, a user selection of an option to augment the display, or the selection of a gear to move the vehicle in reverse. If the condition to augment the rear view display is detected in operation S210—Yes, a first image from a camera that faces an area behind a vehicle and that is located on the rear part of the vehicle is received in operation S220. The received image is then displayed on the rear view display by augmenting the rear view display to display the first image over an image from another camera, such as a second rear-facing camera, in operation S230.

FIG. 3 shows a flowchart for a method for augmenting a rear view display according to another exemplary embodiment. The method of FIG. 3 may be performed by the apparatus that augments a rear view display 100 or may be encoded into a computer readable medium as instructions that are executable by a computer to perform the method.

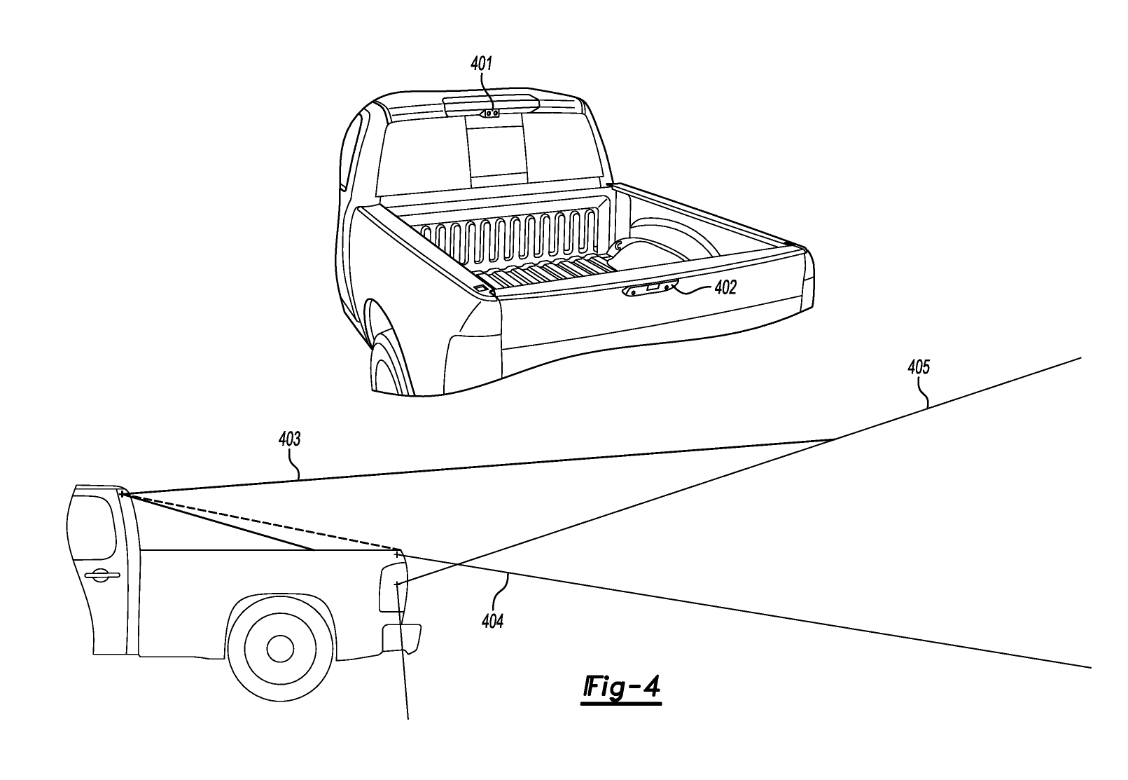

Referring to FIG. 3, an obstruction in a first image taken by a center high-mounted stop light camera is continuously checked for in operation S310 and S310—No. If there is an obstruction (operation S310—Yes), a second image from a second camera facing an area behind a vehicle and that is located on a rear portion of a vehicle is received and processed in operation S320. Next, a part of second image is displayed on the rear view display in place of a part of the first image that is obstructed in operation S330. The part of the first image that is replaced may be the portion corresponding to obstructed part of field of view 403 in FIG. 4. The part of the second image that replaces the obstructed part of the first image may correspond to the recaptured field of view 405 captured by camera 404 as shown in FIG. 4

FIG. 4 shows illustrations of rear facing cameras and their fields of view according to an aspect of an exemplary embodiment. Referring to FIG. 4, a CHMSL 401 is mounted near the top of a cab of a truck on the stop light assembly. In addition, a low mount rear view camera 402 is mounted on a tailgate of a truck. However, the rear facing cameras are not limited to being mounted in the two aforementioned locations and may be mounted in other locations to face an area behind the vehicle or face other areas around a vehicle.

In addition, the field of view of CHMSL camera 401 is shown as 403 and the field of view of low mount rear view camera 402 is shown as 404. The combined images from the cameras may be used to display a wider recaptured field of view shown as recaptured field of view 405.

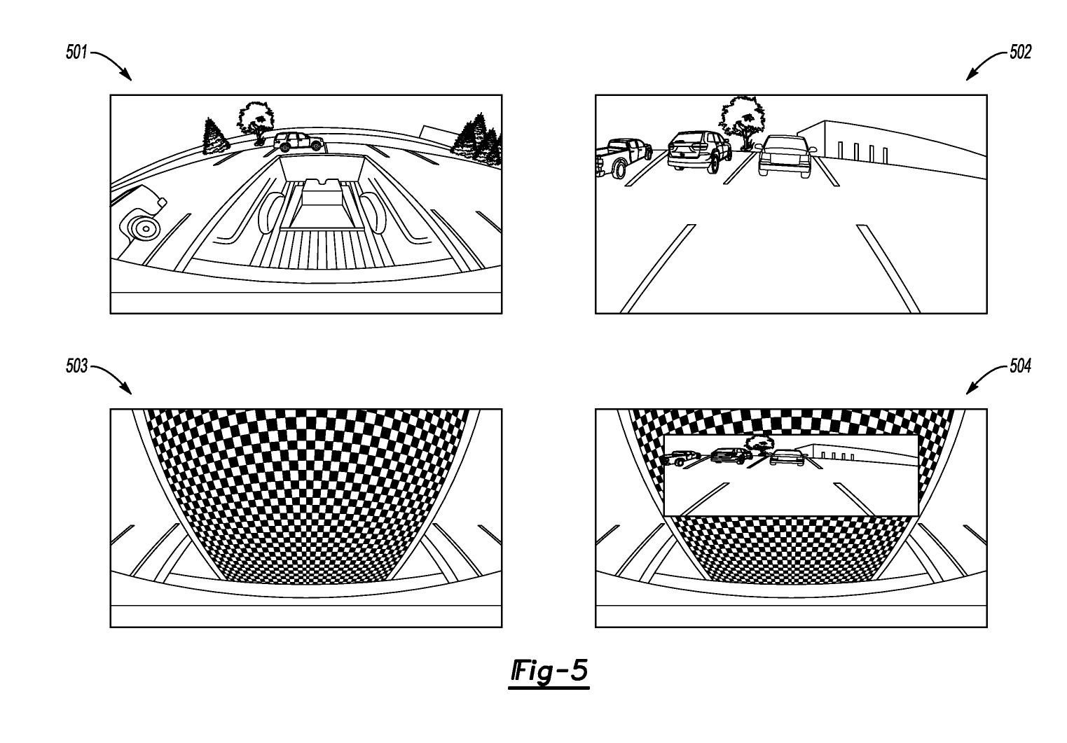

FIG. 5 shows illustrations of various views from rear facing cameras according to an aspect of an exemplary embodiment. Referring to FIG. 5, an example of unobstructed CHMSL camera image is shown in 501 and an unobstructed image from a rear view low mounted camera is shown in 502. As shown in 503, if an image from the CHMSL camera becomes obstructed by cargo in the vehicle bed, an operator of a vehicle can no longer see what is behind the vehicle. Thus, an augmented image 504 is displayed in place of the obstructed image 503. The augmented image 504 includes image 503 and is augmented such that a part of image 502 is displayed in place of a part of image 503. In other words, images 502 and 503 are combined to be displayed on vehicle display to provide a vehicle operator with a better view of an area behind the vehicle.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method for augmenting a rear view display, the method comprising:
detecting a condition for augmenting a rear view display; and
in response to detecting the condition for augmenting the rear view display, receiving a first image from a first camera facing a first area behind a vehicle and displaying the received first image on the rear view display.

2. The method of claim 1, wherein the detecting a condition for augmenting a rear view display comprises:
detecting that a tailgate of the vehicle is closed; and
in response to detecting that the tailgate of the vehicle is closed, detecting a user selection of an option to augment the rear view display.

3. The method of claim 1, wherein the detecting a condition for augmenting a rear view display comprises:
detecting that a tailgate of the vehicle is closed; and
in response to detecting that the tailgate of the vehicle is closed:
performing an edge detection algorithm to detect edges of a tailgate and bed in a second image received from a second camera facing a second area behind a vehicle; and
determining that a portion of the edges of the tailgate and bed that is obscured is greater than a predetermined calibration value based on the edge detection algorithm.

4. The method of claim 3, wherein the displaying the received first image on the rear view display comprises:
determining whether the portion that is obscured is required to be displayed;
determining a location of the portion that is obscured and that is required to be displayed;
determining a dimension of the portion that is obscured and that is required to be displayed;
determining a portion of the received first image that corresponds to the portion that is obscured in the second image; and
cropping and superimposing the portion of the first image that corresponds to the portion that is obscured in the second image onto the portion that is obscured in the second image.

5. The method of claim 1, wherein the displaying the received first image on the rear view display comprises cropping and superimposing the received first image on the rear view display.

6. The method of claim 1, wherein the rear view display comprises a rear view mirror, and
wherein the displaying the received first image on the rear view display comprises cropping and superimposing the received first image on at least a portion of the rear view mirror.

7. The method of claim 1, wherein the rear view display comprises a center stack display, and
wherein the displaying the received first image on the rear view display comprises cropping and superimposing the received first image on at least a portion of the center stack display.

8. The method of claim 1, wherein the first camera comprises a rear vision back up camera located on a tailgate or a trunk of vehicle.

9. The method of claim 1, wherein the rear view display is displaying an image taken by a center high-mounted stop light camera, and
wherein the displaying the received first image on the rear view display comprises cropping and superimposing the received first image on at least a portion of the image taken by the center high-mounted stop light camera.

10. A non-transitory computer readable medium comprising computer executable instructions executable by a processor to perform the method of claim 1.

11. An apparatus for augmenting a rear view display, the apparatus comprising:
at least one memory comprising computer executable instructions; and
at least one processor configured to read and execute the computer executable instructions, the computer executable instructions causing the at least one processor to:
detect a condition for augmenting a rear view display; and
in response to detecting the condition for augmenting the rear view display, receive a first image from a first camera facing a first area behind a vehicle and control to display the received first image on the rear view display.

12. The apparatus of claim 11, wherein the computer executable instructions cause the at least one processor to detect a condition for augmenting a rear view display by:
detecting that a tailgate of the vehicle is closed; and
in response to detecting that the tailgate of the vehicle is closed, detecting a user selection of an option to augment the rear view display.

13. The apparatus of claim 11, wherein the computer executable instructions cause the at least one processor to detect a condition for augmenting a rear view display by:
detecting that a tailgate of the vehicle is closed; and
in response to detecting that the tailgate of the vehicle is closed:
performing an edge detection algorithm to detect edges of a tailgate and bed in a second image received from a second camera facing a second area behind a vehicle; and
determining that a portion of the edges of the tailgate and the bed that is obscured is greater than a predetermined calibration value based on the edge detection algorithm.

14. The apparatus of claim 13, wherein the computer executable instructions cause the at least one processor to control to display the received first image on the rear view display by:
determining whether the portion that is obscured is required to be displayed;
determining a location of the portion that is obscured and that is required to be displayed;
determining a dimension of the portion that is obscured and that is required to be displayed;
determining a portion of the received first image that corresponds to the portion that is obscured in the second image; and
cropping and superimposing the portion of the first image that corresponds to the portion that is obscured in the second image onto the portion that is obscured in the second image.

15. The apparatus of claim 11, further comprising a rear view display including at least one from among a rear view mirror, a center stack display, an instrument panel display, and a heads up display.

16. The apparatus of claim 15, wherein the computer executable instructions cause the at least one processor to control to display the received first image on the rear view display by cropping and superimposing the received first image on the rear view display.

17. The apparatus of claim 11, further comprising the first camera located on the rear portion of the vehicle,
wherein the first camera comprises a rear vision back up camera located on a tailgate or a trunk of vehicle.

18. The apparatus of claim 11, further comprising a center high-mounted stop light camera,
wherein the computer executable instructions cause the at least one processor to control the rear view display to display an image taken by the center high-mounted stop light camera.

19. The apparatus of claim 18, wherein the computer executable instructions cause the at least one processor to control to display the received first image on the rear view display by cropping and superimposing the received first image on at least a portion of the image taken by the center high-mounted stop light camera.

20. A non-transitory computer readable medium comprising computer executable instructions executable by a processor to perform a method for augmenting a rear view display of a vehicle, the method comprising:
detecting an obstruction in a first image taken by a center high-mounted stop light camera;
in response to detecting the obstruction, receiving a second image from a second camera located on a rear portion of a vehicle; and
displaying at least a part of second image in place of a part of the first image on the rear view display.
